(19) United States
(12) Patent Application Publication
(10) Pub. No.: US 2019/0317930 A1
(43) Pub. Date: Oct. 17, 2019

(54) DATA STORAGE SYSTEM

(71) Applicant: BRITISH TELECOMMUNICATIONS PUBLIC LIMITED COMPANY, London (GB)

(72) Inventors: Pushkar MISHRA, Bangalore (IN); Rakesh KANNAN, Karnataka (IN)

(21) Appl. No.: 16/313,599

(22) PCT Filed: Jun. 15, 2017
(86) PCT No.: PCT/EP2017/064706

§ 371 Date: Dec. 27, 2018

(30) Foreign Application Priority Data
Jun. 30, 2016 (IN) 201611022486
Aug. 30, 2016 (EP) 16186413.7

(51) Int. Cl. G06F 16/22; G06F 16/245; G06F 16/23

(52) U.S. Cl. CPC G06F 16/2219; G06F 16/2365; G06F 16/245

(57) ABSTRACT

A system comprises a data system interface, a database system and a data object storage interface. The data system interface receives a request issued by a requester to retrieve content data from the database system; forwards the request to the database system; receives in response, non-content data relating to a data object stored in a data object storage; forwards to the data object storage interface: the non-content data and details of the request; receives from the data object storage interface, a response comprising the content data; and forwards the content data to the requester. The data object storage interface receives details of the request, together with non-content data; forwards them to the data object storage, receives from the data object storage a data object comprising the content data; and forwards to the data system interface the content data.

### FIELD OF THE INVENTION

The present invention relates to a data storage system, for example in a communications network.

### BACKGROUND OF THE INVENTION

There is an increasing need to store ever larger amounts of data in a structured and readily accessible form, such as is provided by a database. However, a conventional database may be unsuitable for accommodating very large data objects, such as video or audio files. A database is conventionally expanded by enhancing the implementing hardware, for example by increasing storage (RAM or SSD). Such hardware enhancements are expensive and lead to “downtime” during each upgrade. There is a need for a way to increase the effective storage capacity of a database while avoiding the expense and disruption of a hardware upgrade.

### SUMMARY OF THE INVENTION

The invention allows the effective storage capacity of a database to be increased by storing data such as character large object (CLOB) and binary large object (BLOB) data objects in a data object storage system, such as cloud storage, together with storing associated non-content data (such as metadata) in a database. According to an embodiment of the invention, the data object storage system may be remote from the database—such as remote cloud storage. By using a data object storage system, in this way, data storage may be flexibly and transparently expanded at reduced cost and avoiding downtime while maintaining the benefits of structured data storage.

The invention accordingly provides in a first aspect, a method comprising a data system interface, a database system and a data object storage interface, in which the method comprises, at the data system interface:

receiving a request issued by a requester to retrieve content data from the database system;

forwarding details of the request to the database system; receiving from the database system a response comprising non-content data relating to a data object stored in a data object storage; forwarding to the data object storage interface: the non-content data and details of the request; receiving from the data object storage interface, a response comprising the content data; and forwarding the content data to the requester.

The invention accordingly provides in a second aspect, a method comprising a data system interface, a database system and a data object storage interface, in which the method comprises, at the data object storage interface:

receiving from the data system interface, details of a request issued by a requester to retrieve content data from the database system, together with non-content data relating to a data object stored in a data object storage; in which the non-content data are retrieved from the database system; forwarding to the data object storage, the details of the request and the non-content data; receiving from the data object storage a response, in which the response comprises a data object comprising the content data; and forwarding to the data system interface the content data.

According to an embodiment, the invention provides a method comprising the above two methods.

According to an embodiment, the request issued by the requester is interpretable in the database system as indicating a query statement indicating that the requested data is held in data object storage.

According to an embodiment, the request issued by the requester is interpretable in the database system as indicating a query statement comprising the non-content data.

According to an embodiment, the non-content data indicates a location of the data object in the data object storage.

According to an embodiment, the non-content data comprises at least one of version and time non-content data relating to at least one data object stored in the data object storage.

According to an embodiment, the method further comprises, at the data object storage interface, using the non-content data to ensure absolute consistency of at least one data object stored in the data object storage.

According to an embodiment, the method further comprises, at the data object storage interface, initiating a comparison of the non-content data received with the request to non-content data for the data object received from the object storage; in which the non-content data comprises at least one of version and time data.

According to an embodiment, the comparison indicates that the non-content data received with the request and the non-content data for the data object received from the object storage do not match, the object storage interface provides an instruction to apply a lock on a record associated with the object in the database system.

According to an embodiment, the lock is removed once non-content data for the data object received from the object storage are found to match the non-content data received with the request.

According to an embodiment, the method further comprises, at the data system interface:

receiving from a requester, a request to store content data in the database system; forwarding content data associated with the request to the data object storage interface for storing in the data object storage; and forwarding non-content data associated with the request to the database system.

According to an embodiment, the method further comprises, storing in the database system non-content data defining an association between non-content data stored in the database system and a location in the data object storage for storing the content data.

The present invention accordingly provides, in a third aspect, a computer program element comprising computer program code to, when loaded into a computer system and executed thereon, cause the computer to perform the steps of the method set out above.

The invention also provides in a fourth aspect, a system comprising a data system interface in which the data system interface comprises:

a first interface for communicating with a requester device; in which the first interface is configured to receive from the requester device, a request to retrieve a data object from the database system;

a second interface for communicating with a database system; in which the second interface is configured to forward details of the request to the database system; and to receive a response from the database system, in which the response comprises metadata relating to a data object stored in a data object storage; and

a third interface for communicating with a data object storage through an object storage interface; in which the third interface is configured to forward to the object storage interface details of the request and the metadata.

The invention provides in a fifth aspect, a system comprising:

a data object storage interface in which the data object storage interface comprises: a first interface for communicating with a data system interface and through the data system interface with a requester and a database system; in which the first interface is configured to receive from the data system interface, a request, issued by a requester, to retrieve content data from the database system; receive from the data system interface, non-content data relating to a data object comprising the requested content data stored in a data object storage; and forward to the data system interface for delivery to the requester, content data comprised in a data object received from the data object storage;

a second interface for communicating with the data object storage; in which the second interface is configured to forward to the data object storage details of the request, the non-content data; and receive from the data object storage in response, a data object.

According to an embodiment, the invention also provides a system comprising both the above two systems.

According to an embodiment, the non-content data is derived from the database system. According to an embodiment, the data object storage is a cloud storage.

The present invention accordingly provides, in a sixth aspect, a computer program element comprising computer program code to, when loaded into a computer system and executed thereon, cause the computer to perform the steps of the method set out above.

### BRIEF DESCRIPTION OF THE DRAWINGS

In order that the present invention may be better understood, embodiments thereof will now be described, by way of example only, with reference to the accompanying drawings in which:

FIG. 1 shows a schematic system diagram according to embodiments of the invention;

FIG. 2 shows a database table and data object storage system arrangement according to embodiments of the invention;

FIGS. 3, 4 and 5 show logic diagrams according to embodiments of the invention; and

FIG. 6 is a block diagram of a computer system suitable for the operation of embodiments of the present invention.

### DETAILED DESCRIPTION OF THE PREFERRED EMBODIMENTS

The invention provides for management of data objects, which may comprise a large amount of content data by storing a relatively small amount of non-content data (e.g. metadata) relating to the data object in a databases as block storage, while storing the large amount of content data in data object storage. According to an embodiment, the data object storage used is cloud storage. The invention provides advantages similar to those that would be experienced from storing the data object in the database while avoiding having to support a database large enough to store large quantities of content-data. The invention allows a requester to use sophisticated database techniques to find and manipulate large data objects stored in data object storage as if they were all held in the database.

Cloud storage provides massive scale (10s to 100s of petabytes and billions of data objects) and direct access over HTTP and is approximately ten times less expensive per byte than block storage. A problem with cloud storage is that it does not support an operating system or a database structure. Despite this, the invention effectively extends a database controlled by a database management system (DBMS) to include cloud storage. This is done, according to the invention, by using data segregation. Data is segregated between those data, such as non-content data, that need to be stored in a block storage system and those data, such as content data, that do not. The association between the non-content data and the content data can be maintained when they are stored separately by means of a reference key. According to the invention, no database structure is necessary in the data object storage system. A database structure is implemented in block storage, which stores version- and time-related information relating to data objects stored in the data object storage system, effectively creating a virtual database across the database and the data object storage system.

Hence although cloud storage does not support a database structure, the database structure that is embodied by the DBMS may be used to access and manipulate blocks stored in cloud storage, through the use of reference keys. An example of a suitable reference key is: http://cms-backamaze.gb.storage.cloud.bt.com/Locfilename∥12345, where “http://cms-backamaze.gb.storage.cloud.bt.com” is a reference to a cloud storage system in which “cms-backamaze” is the name of a container where all files are stored and organized and “gb.storage.Cloud.bt.com” is specific to a cloud provider. Also in this example reference key, “Locfilename” is the name of a file and “12345” is the version number of the file.

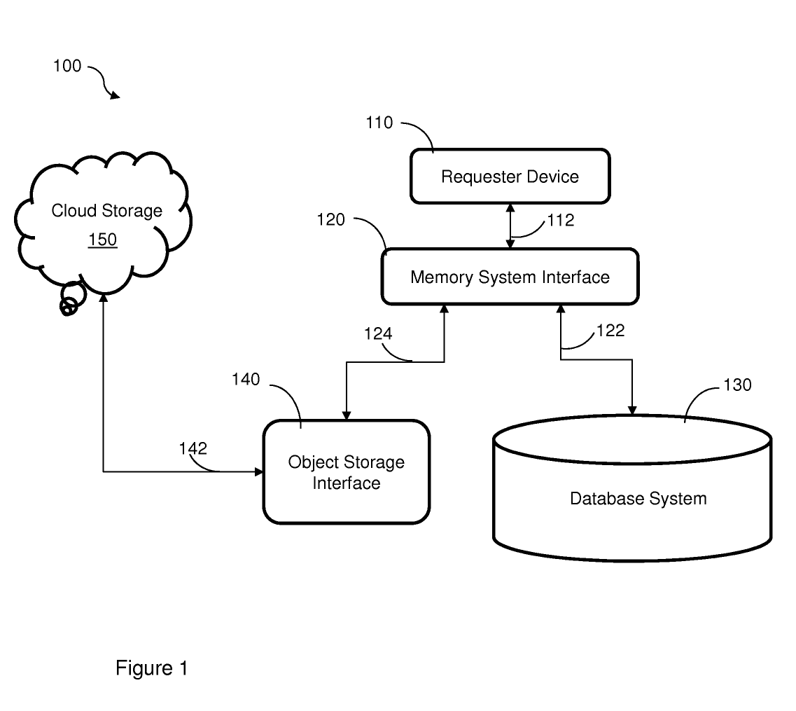

FIG. 1 shows a communications network 100, comprising database system 130 and data object storage 150, according to embodiments of the invention. In FIG. 1, requester device 110 is connected to data system interface 120 by a connection, for example using HTTP over TCP/IP, for the exchange of messages for interrogating and modifying the contents of database system 130. Advantageously, the requester need have no knowledge of data object storage 150. According to an embodiment of the invention, data system interface 120 functions to interface with the requester device 110 and to present to the requester the data system (i.e. database system 130, data object storage interface 140 and data object storage 150) as if it consisted solely of database system 130. To this end, data system interface 120 integrates, for forwarding to the requester, data retrieved from data object storage 150 and database system 130 and segregates data received from the requester, which is to be stored in data object storage 150 from that which is to be stored in database system 130. Database system 130 comprises a database storing a collection of interrelated, structured data and a software management system (e.g. DBMS) to manage the data in the database. Data object storage 150 (for example cloud storage) is capable of storing data objects, such as CLOB and BLOB data objects of various sizes, including but not limited to objects that are too large to be stored in database system 130 or objects whose size would have a detrimental effect on the performance of a database to at least a predetermined extent. Reference in the following to cloud storage includes any suitable data object storage.

The requester device 110 may comprise a computer, smart phone, tablet device, or other device that comprises a processor and a computer network interface (e.g., Wi-Fi or a wired network interface card). A suitable system is shown in FIG. 7. The data system interface 120 may act as interface to database system 130 and, in some embodiments, the data system interface 120 may comprise part of the database system 130 and thus may execute on the database system. In the configuration shown in the Figure, data system interface 120 is connected by a connection 122 for forwarding to the database system 130, requests received from the requester device and for receiving responses from the database. Data system interface 120 is also connected by a connection 124 to data object storage interface 140 for interaction and exchange of both content and non-content data with data object storage interface 140 and, through data object storage interface 140, by a connection 142 with cloud storage 150. Data object storage interface 140 may be deployed in an application server. According to an embodiment, data system interface 120, database system 130 and data object storage interface 140 are all located in a local area, for example all connected to the same local area network (LAN) and database system 130 comprises block storage. According to a further embodiment, data system interface 120, database system 130 and data object storage interface 140 are all located in the same data-centre to decrease network latency and increase throughput. According to a further embodiment, data system interface 120, database system 130, data object storage interface 140 and cloud storage 150 all occur in a single system, for example a computer system virtualising a network of multiple systems.

According to an embodiment, cloud storage 150 is located remotely from data system interface 120 and is typically accessed over the internet 142. In practice, cloud storage 150 may be located in datacentres anywhere around the world. According to an embodiment, each of requester device 110, data system interface 120, database system 130, data object storage interface 140 and data object storage 150 are controlled by program code executed by a processor. An exemplary processor and associated processing circuit is shown in FIG. 7.

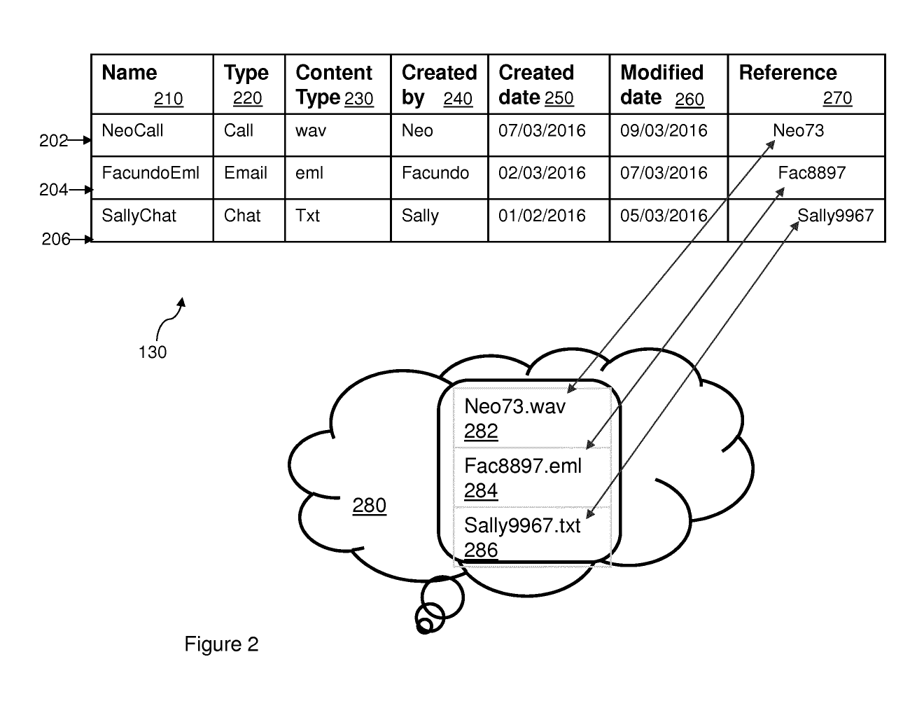

FIG. 2 shows an excerpt from a database in database system 130, in which the excerpt comprises three records 202, 204, 206, with each record comprising a plurality of fields, i.e.: Name 210, Type 220, Content Type 230, Created Date 250, Modified Date 260 and Reference 270. Each record 202, 204, 206 corresponds to a file stored in database system 130. FIG. 2 also shows data object storage 280, which stores three data objects: Neo73.wav 282, Fac8897.eml 284 and Sally9967.txt 286. It will be noted that each of the data objects stored in data object storage 280 has a corresponding record in the database. That is data objects Neo73.wav 282, Fac8897.eml 284 and Sally9967.txt 286 each have a corresponding record 202, 204 and 206, respectively, in the database, as indicated by reference field 270 of each of record. The other fields in database system 130 are explained next. Name 210 is non-content data to indicate the name of the database data object. Type 220 is non-content data to indicate the type of data object to be stored, typically at the level of email, call, chat, video conference, etc. Content Type 230 is non-content data to indicate the extension of the data object to be stored. Where extension may be a way data object (audio), JPEG data object (picture), PDF (a document), etc. Created Date 250 is non-content data to indicate the date when the data object was first created. Modified Date 260 is non-content data to indicate when the data object was last modified.

We now provide a more detailed description of certain embodiments.

Storing Data

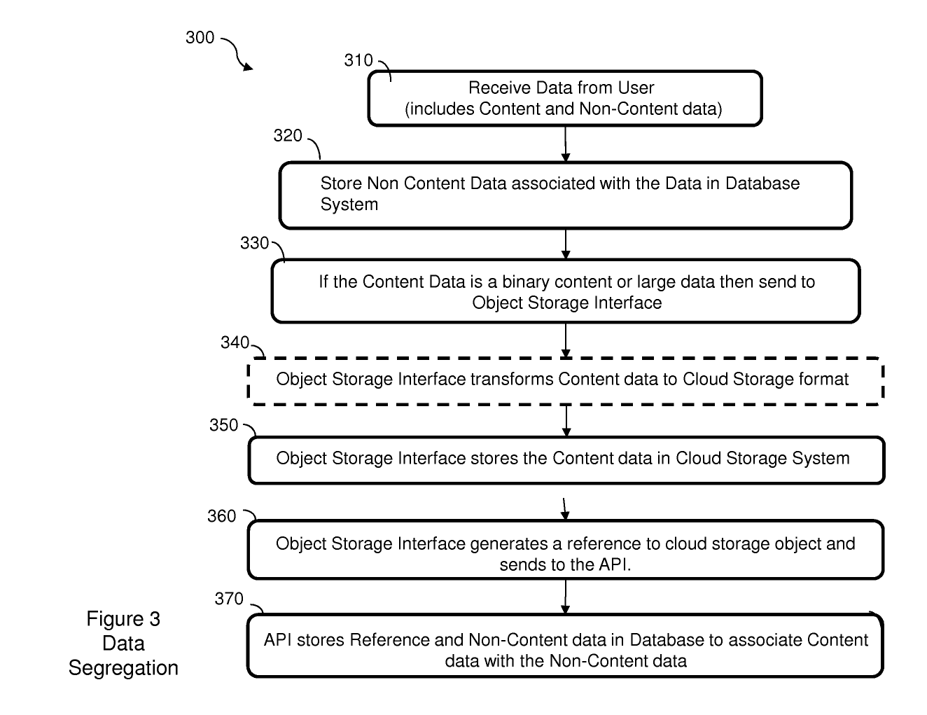

With reference to FIG. 3, data system interface 120 receives (310) a large content-data object and related non-content data from the requester. All BLOBs, CLOBs and recognised custom data-types are considered as content data by data system interface 120. Other data, received from the requester which are neither BLOBs, CLOBs nor a recognised custom data-type are automatically considered as non-content data by data system interface 120. Data system interface 120 stores (320) non-content data associated with the content data in database system 130. Data system interface 120 sends (330) the content data to data object storage interface 140, which transforms (340) the content data into cloud storage format (where necessary). Data object storage interface 140 then stores (350) the content data in cloud storage 150. On receiving a request to store data, the data object storage interface 140 makes a restful or HTTP call to the cloud storage 150. On receiving confirmation from cloud storage 150 that the data object has been successfully stored, the data object storage interface 140 Interface generates (360) a reference key and requests the data system interface to store in the database system 130, the reference key together with version and time stamp non-content data, generated by the cloud storage 150 on successfully storing the data object in a datacentre. The reference key comprises details of how to access the content data stored in the cloud storage 150 (e.g. reference to the address of data objects in the cloud storage). The reference key is stored together with the non-content data in the database system 130 to indicate the location of the content data stored in cloud storage 150. Data object storage interface 140 sends the reference key to data system interface 120 which stores (370) the reference key in database system 130 together with version and time stamp non-content data and other non-content data, where provided by the requester.

Consider, for example, a database table called “person” which comprises an ID (as a number), a person's name, a photo of the person and their curriculum vitae. Since large documents, such as image and CV can occupy a large amount of memory, it is advantageous to store them in a cloud storage. According to an embodiment of the invention, to facilitate this segregated storage in a way that allows the documents to be retrieved using a simple database request, data definition language (DDL) SQL statements containing the key word “CLOUD” may be used. The key word “CLOUD” in the DDL statement may be used to maintain internal reference keys in database system 130 and as an identifier that large documents are stored in a cloud storage across one or multiple servers. A suitable table creation statement is provided in Table 1:

TABLE 1

```
CREATE table person (
              id number,
              name varchar2(50),
              image blob CLOUD,
              CV varchar2(500) CLOUD,
              Documents CLOUD,
              ...
              )
```

The data system interface 120 identifies which fields are to be stored in block memory of the database system 130 and which are to be stored in cloud storage 150. The latter are distinguished by having the key word “CLOUD” associated with them in the database. Advantageously, to an end user or requester, the resulting segregated storage appears to be a single database running on a single machine.

Where the database system 130 is a distributed system across multiple servers, data object storage interface 140 may generate the reference key once only but instruct the data system interface 120 to pass the reference key (together with the non-content data) to each one of the multiple servers. Even where non-content data is replicated across multiple servers, however, a single version of the content data may be maintained in the cloud storage. All copies of the non-content data for a specific chunk of content data are associated with the same reference key.

Accessing Data

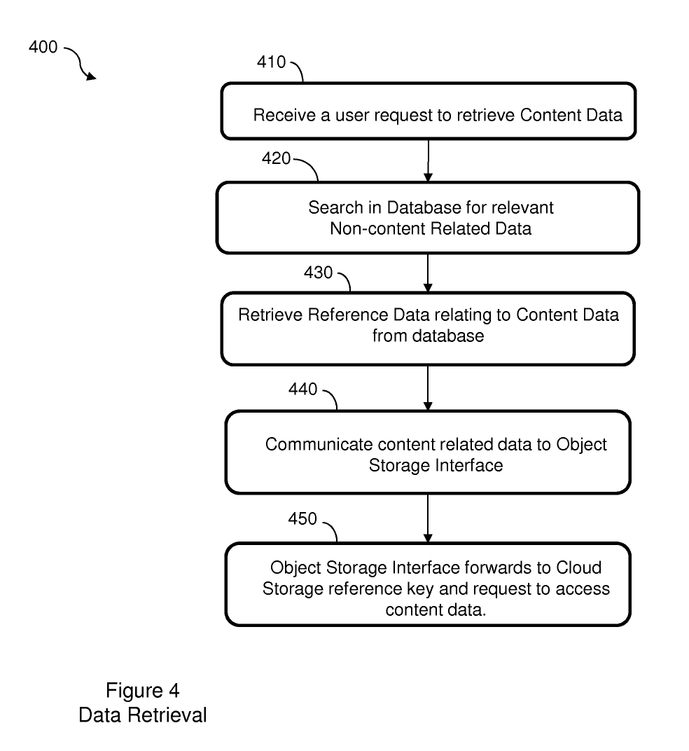

Retrieval of data from the cloud storage and modification of data in the cloud storage is initiated by a database request generated by a requester at requester device 110. Retrieval of content data is based on non-content data. Non content data may be Name, Type, Content Type, etc. (as shown by way of example in FIG. 2). When a request to fetch content data is received, the content data is retrieved from the data object storage. FIG. 4 illustrates retrieval of data from the data object storage according to an embodiment of the invention. A Request for retrieval contains non-content data, for example, in the request: “Select * from person where id=1”, “id=1” is non-content data. The response to this request may contain content and non-content data. Content data contained in the response is fetched from data object storage 150, while non-content data contained in the response is fetched from the database system 130. Referring to FIG. 4, when requester device 110 sends (410) to data system interface 120 a request to access data, the request (or details of the request) is routed to the database system 130, where a search operation (420) is carried out only on the non-content data stored in database system 130. The search may, if successful, identify a reference key pointing to content data located in data object storage 150. As a result of the search 420, the database system 130 retrieves (430) information, including the reference key, relating to one or more data objects in cloud storage 150. The request can be interpretable in the database system as indicating a query statement indicating that the requested data is held in data object storage. The request issued by the requester can be interpretable in the database system as indicating a query statement comprising the non-content data. This information, together with details of the request, is communicated (440) via the data system interface 120 to the data object storage interface 140. Data object storage interface 140 forwards (450) to cloud storage 150, the reference key, together with a request to retrieve or modify content data according to the details in the requester's request. To an end user or requester, data objects stored in cloud storage 150 appear to be part of a single database running on a local machine.

According to an embodiment of the invention, retrieval of data from the cloud storage uses data aggregation. With data aggregation, when data is retrieved, e.g. by use of a reference key, the relevant data from the cloud storage and from database system 130 is aggregated. When data object storage interface 140 receives the requested content data retrieved from the cloud storage 150, it is forwarded to data system interface 120. On receipt of the retrieved content data from data object storage interface 140, data system interface 120 aggregates the associated non-content data from the database system 130 with the retrieved content data and forwards, in a response to the request, the aggregated information to the requester device 110. The system acts to virtually extend the database by use of a cloud storage, even though the DBMS cannot be installed on a cloud storage system or any cloud storage.

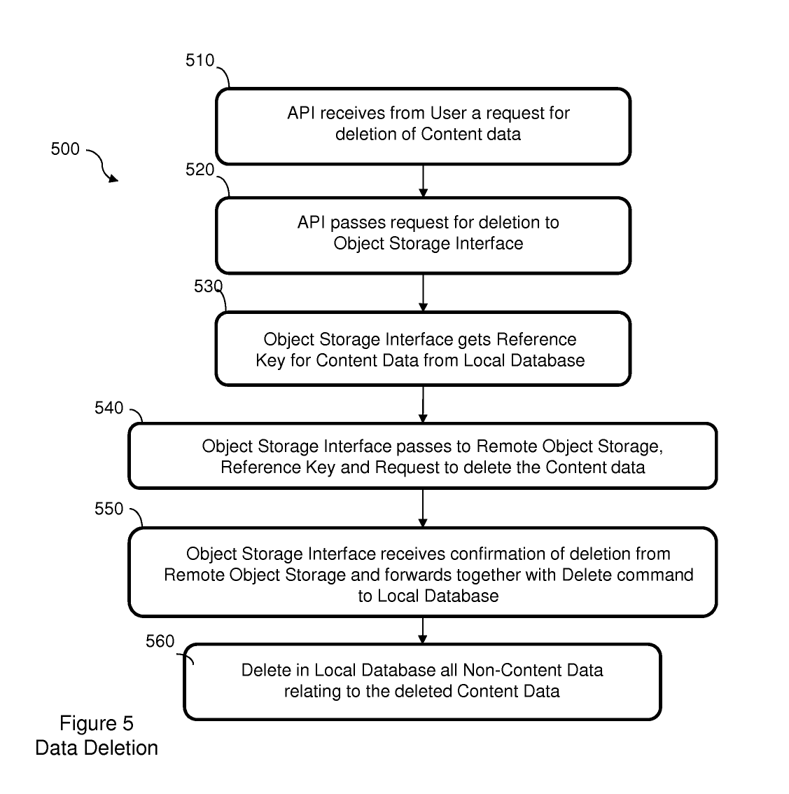

Deleting Data FIG. 5 relates to deletion, based up on requester request, of content data from data object storage 150 using data system interface 120 and data object storage interface 140. Referring to FIG. 5, when data system interface 120 receives (510) a request generated by the requester for Content data to be deleted, data system interface 120 passes (520) details of the request for deletion to data object storage interface 140. Data object storage interface 140 obtains (530) via data system interface 120 from database system 130, the relevant reference key and passes (540) the key together with a “delete” command to the data object storage 150. On receiving confirmation from the data object storage that the deletion was successful, data object storage interface 140 passes (550) via data system interface 120 the reference key together with a “delete” command to the database system 130. On receipt of the delete command, the database system 130, using the reference key as an index, removes (560) the non-content data relating to the deleted content data.

Advantageously, the invention is able to move a large quantity of data to a low-cost cloud storage such as cloud storage, which results in a much smaller database. This can mean the database can be accommodated in fast-access RAM memory, whereas a conventional, larger database may be too large for RAM and will need to be stored in slower discs memory. RAM takes nanoseconds to read from or write to, while hard drive access speed is measured in milliseconds. Hence the invention can significantly improve the performance of a database.

The invention effectively maintains a single, virtual database across two different storage systems, one main, block storage (typically local and fast but expensive) and another cloud storage (typically remote and inexpensive but slow). The main memory stores data as blocks. With block storage, files are split into evenly sized blocks of data, each with its own address but with no additional information (non-content data) to provide more context for what that block of data is. The cloud storage stores data as data objects. Data object storage, by contrast, does not split files up into blocks of data. Instead, entire clumps of data are stored as a single data object that contains the data, non-content data, and the unique identifier. Data object storage does not store information on relationships between data objects, which is done in the database. There is no limit on the type or amount of data which can be stored in data object storage, which makes data object storage powerful and customizable.

Consistency

Even after integrating with data object storage, the invention achieves atomicity, consistency, isolation, and durability (ACID)—which are the desired properties of a relational database system. As we have indicated, above, cloud storage does not support database properties, in particular, cloud storage is not strongly consistent. Consistency is achieved as follows, according to an embodiment of the invention.

The database system 130 sends messages with information (e.g. version and time non-content data and reference key) to the data object storage interface 140. The database system may interact with the data object storage interface when DML commands are executed in the database system, for example, when data needs to be fetched, stored or deleted from data object storage. During execution of DDL statements, such as “create table operation”, the data system interface 120 behaves as a plugin to the database to store data about the data objects (such as CLOBs, BLOBs and user defined data) that is to be stored in data object storage. The data system interface segregates data which is to be stored in data object storage from data which is to be stored in the database system. When we refer to “data object storage”, this term includes storage systems in which the data may be replicated across multiple servers. In particular, we use the term “data object storage” to include cloud storage.

A problem with certain forms of data object storage, for example conventional cloud storage, is a lack of absolute consistency, because cloud storage only supports eventual consistency wherein retrieving a data object may not return the latest version of the data object, but an older version. That is, subsequent attempts to read a data object from cloud storage may or may not yield the latest version of the data object. Cloud storage may store a data object across a variety of data-centres located at different geographical locations. This provides durability and also resilience against failure of a single data-centre. When the data object is stored in one of the data centres a success message is returned to the requesting client, together with version and time non-content data. When a data object is read from cloud storage, the cloud storage may try to retrieve the data object from a data-centre close to the data centre where the request was made but this may not be the data-centre in which the data object was most-recently stored—resulting in the return of a data object with old version and time non-content data.

According to the invention, the version and time non-content data related to a data object stored in data object storage are also recorded in the database. Consistency is maintained by the database system 130 which keeps track of the version and time stamp of each data object stored in data object storage. Whenever a requester of the present invention provides a data object together with a request for storage, the data system interface 120 directs the data object to the data object storage interface 140, from where it is passed to the data object storage 150. When the data object is stored in the cloud storage, a copy of the latest relevant version and time non-content data is stored in the database system. Unlike data object storage, the database system is naturally, strongly consistent. The inherent consistency of the database system is exploited according to an embodiment of the invention to ensure consistent behaviour on the part of the data object storage. According to this embodiment, whenever the data system interface issue a data-retrieval request to the data object storage interface, it is accompanied by version and time non-content data relating to the requested data object and retrieved from the database. When the data object storage provides a data object in response to a data-retrieval request, it is accompanied by version and time non-content data relating to the provided data object and retrieved by the data object storage. When the data object storage interface receives a data object in response to a data-retrieval request, it compares the version and time non-content data relating to the requested data object retrieved from the database with the version and time non-content data for the data object received from the data object storage. If the non-content data do not match, the data object storage interface applies a lock on the record associated in the database 130 with the data object until matching non-content data are received from the data object storage. In the presence of a mismatch, the data object storage interface may apply a configurable time limit for retries and a configurable limit on the number of retries. The data object storage interface may retry retrieval of the data object until it receives from the data object storage, version and time non-content data that matches the version and time non-content data held in the database. When matching version and time non-content data are received, the data object storage interface returns the data object to the data system interface 120 for delivery to the requester and the lock is released.

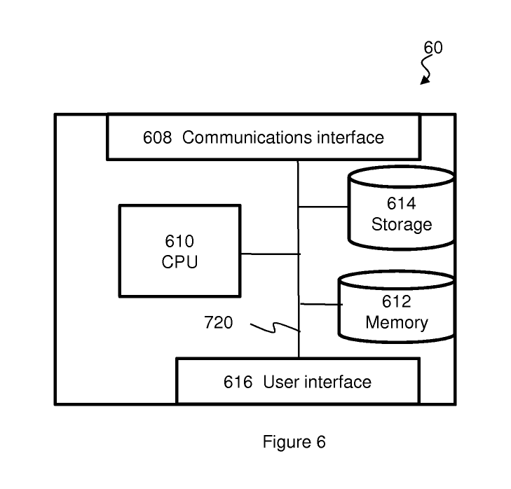

FIG. 6 is a block diagram of a computer system 60 suitable for the operation of embodiments of the present invention. A central processor unit (CPU) 610 is communicatively connected to communications interface 608, a memory 612, a storage 614 and an input/output (I/O) interface 616 via a data bus 520. The memory 612 can be any read/write storage device such as a random access memory (RAM) or a non-volatile storage device suitable for storing data for use by processor 612. The storage 614 can be any read-only or read/write storage device such as a random access memory (RAM) or a non-volatile storage device suitable for storing program code for controlling the operation of processor 610. Memory 612 and storage 614 may comprise the same device or devices. An example of a non-volatile storage device includes a disk or tape storage device. The user interface 616 is an interface to devices for the input or output of data provided to or received from a user or operator of computer system 60. Examples of I/O devices connectable to user interface 616 include a keyboard, a mouse, a display (such as a monitor) and a network connection. Communications interface 608 is an interface to other devices and may comprise one or more radio transmit interfaces and one or more wired or wireless core network interfaces.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as data object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention. The invention is not restricted to large data objects and has application to data objects comprising any amount of content data.

According to an embodiment, the data object storage interface uses REST or HTTP methods over the web to retrieve data object content from a cloud storage. According to embodiments, the data held in a cloud storage system may be stored in any availability zone (i.e. a data centre in a region of a remote cloud storage) at any time. According to embodiments, data in a cloud storage system can be moved between different data centres in a region of a cloud storage system without this affecting the ability of the data system interface 120, database system or data object storage interface 140 to locate the data by use of the reference key.

The invention is not limited to cloud storage and may be applied to any data storage capable of dealing efficiently with large data objects. However, use of cloud storage provides the benefits of low cost, no up-front cost, pay-as-you-go model, highly scalable, auto-scalable and high availability. According to an embodiment of the invention, the data object storage or cloud storage is remote from the requester and the database system, by which we mean not directly connected to the same network as the data system interface, database system or object storage interface. The data object storage interface 140 may have the capability to transform the retrieved content data from a cloud storage format to CLOB, BLOB or custom data-type, as appropriate, before forwarding to data system interface 120. The data object storage interface 140 may also encrypt the content data using various encryption method such as AES (Advanced Encryption Standard) prior to storing in the cloud storage 280. However, encryption of content data is optional. Data object storage interface 140 may have the capability to check whether the retrieved content data is in encrypted format and, where the content data is encrypted, decrypt using the appropriate key and appropriate decryption method.

The data object storage interface 140 may store credentials relating to a user account with a cloud service provider. As a part of setup, data object storage interface 140 accepts credentials such as user names, passwords, certificates and keys. Data object storage interface 140 may store this information in a properties file or credential store in an application server (i.e. where the application server is the environment for the data object storage interface 140). Using the credentials in combination with an appropriate protocol (such as REST, SOAP, etc.), data object storage interface 140 communicates with the data object storage 150.

Data object storage interface 140 may also add appropriate headers to content data for example—creation date, expiry date, created user name, last modified date, last modified user name, etc. These headers may be useful to identify various attributes associated with the said data for purposes of management of data stored in the cloud, including deletion of data objects. These headers are effectively additional non-content data that are stored in the cloud with the content data and are not in stored in the database system. These headers may be used to maintain consistency across both the database system and data object storage. Part of the headers may also be stored in the database system to ensure consistency across the systems is maintained.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A method comprising:
receiving a request issued by a requester to retrieve content data from a database system;
forwarding details of the request to the database system;
receiving from the database system a response comprising non-content data relating to a data object stored in a data object storage;
forwarding to a data object storage interface: the non-content data and details of the request;
receiving from the data object storage interface, a response comprising the content data; and
forwarding the content data to the requester.

2. A method comprising:
receiving from a data system interface, details of a request issued by a requester to retrieve content data from a database system, together with non-content data relating to a data object stored in a data object storage; in which the non-content data are retrieved from the database system;
forwarding to the data object storage, the details of the request and the non-content data;
receiving from the data object storage a response, in which the response comprises a data object comprising the content data; and
forwarding to the data system interface the content data.

3. A method as in claim 1, further comprising:
receiving from a data system interface, details of a request issued by a requester to retrieve content data from a database system, together with non-content data relating to a data object stored in a data object storage; in which the non-content data are retrieved from the database system;
forwarding to the data object storage, the details of the request and the non-content data;
receiving from the data object storage a response, in which the response comprises a data object comprising the content data; and
forwarding to the data system interface the content data.

4. The method of claim 1, in which the request issued by the requester is interpreted in the database system as a query statement indicating that the requested data is held in data object storage.

5. The method of claim 1, in which the request issued by the requester is interpreted in the database system as a query statement comprising the non-content data.

6. The method of claim 1, in which the non-content data indicates a location of the data object in the data object storage.

7. The method of claim 1, in which the non-content data comprises at least one of version and time non-content data relating to at least one data object stored in the data object storage.

8. The method of claim 1 comprising, at the data object storage interface, using the non-content data to ensure absolute consistency of at least one data object stored in the data object storage.

9. The method of claim 1, comprising, at the data object storage interface, initiating a comparison of the non-content data received with the request to non-content data for the data object received from the object storage; in which the non-content data comprises at least one of version and time data.

10. The method of claim 9, in which, where the comparison indicates that the non-content data received with the request and the non-content data for the data object received from the object storage do not match, the object storage interface provides an instruction to apply a lock on a record associated with the object in the database system.

11. The method of claim 10, in which, the lock is removed once non-content data for the data object received from the object storage are found to match the non-content data received with the request.

12. The method of claim 1, further comprising at the data system interface:
receiving from a requester, a request to store content data in the database system;
forwarding content data associated with the request to the data object storage interface for storing in the data object storage; and
forwarding non-content data associated with the request to the database system.

13. The method of claim 12, further comprising: storing in the database system non-content data defining an association between non-content data stored in the database system and a location in the data object storage for storing the content data.

14. A computer program element comprising computer program code to, when loaded into a computer system and executed thereon, cause the computer to perform the steps of a method as claimed in claim 1.

15. A system comprising a data system interface in which the data system interface comprises:
a first interface for communicating with a requester device; in which the first interface is configured to receive from the requester device, a request to retrieve a data object from the database system;
a second interface for communicating with a database system; in which the second interface is configured to forward details of the request to the database system; and
to receive a response from the database system, in which the response comprises metadata relating to a data object stored in a data object storage; and
a third interface for communicating with a data object storage through an object storage interface; in which the third interface is configured to forward to the object storage interface details of the request, the metadata.

16. A system comprising:
a data object storage interface in which the data object storage interface comprises:
a first interface for communicating with a data system interface and through the data system interface with a requester and a database system; in which the first interface is configured to:
receive from the data system interface, details of a request, issued by a requester, to retrieve content data from the database system;
receive from the data system interface, non-content data relating to a data object comprising the requested content data stored in a data object storage; and
forward to the data system interface for delivery to the requester, content data comprised in a data object received from the data object storage;
a second interface for communicating with the data object storage; in which the second interface is configured to:
forward to the data object storage details of the request and the non-content data; and
receive from the data object storage in response to the request a data object.

17. A system of claim 15, further comprising:
a data object storage interface in which the data object storage interface comprises:
a first interface for communicating with a data system interface and through the data system interface with a requester and a database system; in which the first interface is configured to:
receive from the data system interface, details of a request, issued by a requester, to retrieve content data from the database system;
receive from the data system interface, non-content data relating to a data object comprising the requested content data stored in a data object storage; and
forward to the data system interface for delivery to the requester, content data comprised in a data object received from the data object storage;
a second interface for communicating with the data object storage; in which the second interface is configured to:
forward to the data object storage details of the request and the non-content data; and
receive from the data object storage in response to the request a data object.

18. A system as claimed in claim 15, in which the non-content data are derived from the database system in response to the request.

19. A system as claimed in claim 15, in which the data object storage is a cloud storage.
